(19) United States
(12) Patent Application Publication
(10) Pub. No.: US 2022/0324720 A1
(43) Pub. Date: Oct. 13, 2022

(54) Reaction Chamber for Extraction of Uranium Dioxide Powder by Using Method of Uranium Hexafluoride Reductive Pyrohydrolysis

(71) Applicant: PUBLICHNOE AKTSIONERNOE OBSHCHESTVO "NOVOSIBIRSKT ZAVOD KHIMKONTSENTRATOV"(PAO NZHIK), Novosibirsk (RU)

(72) Inventors: Dmitry Yuryevich OSTROVSKY, g. Novosibirsk (RU); Alexander Leonidovich KHLYTIN, g. Novosibirsk (RU); Yury Vladimirovich OSTROVSKY, g. Novosibirsk (RU); Grigory Mikhailovich ZABORTSEV, g. Novosibirsk (RU); Ivan Ignatyevich ZHERIN, g. Tomsk (RU)

(21) Appl. No.: 17/257,281

(22) PCT Filed: Sep. 5, 2019
(86) PCT No.: PCT/RU2019/000619

§ 371 Date: Dec. 30, 2020

(51) Int. Cl. C01G 43/06; B01J 19/26

(52) U.S. Cl. CPC C01G 43/06; B01J 19/26; B01J 2219/0036

(57) ABSTRACT

Reaction chamber and methods of extraction of metal compounds, specifically tools for uranium hexafluoride (UF₆) conversion into uranium dioxide (UO₂) ceramic powder (up to 5% enrichment of U²³⁵) by applying a method of reductive pyrohydrolysis. In one aspect, the reaction chamber is a shell with upper and lower heads, comprising upper filtration area, equipped with metalceramic filters, regenerating nitrogen, the first reaction zone for conversion of uranium hexafluoride into uranyl fluoride, the second reaction zone with gas-distribution grid for building up fluidization layer for reduction of uranyl fluoride to uranium dioxide with a nozzle of steam, and hydrogen and nitrogen supply. On the side walls of the first reaction zone of the reaction chamber shell there are two nozzles located symmetrically for uranium hexafluoride, hydrogen and water steam supply. The chamber is equipped with a device for discharge of powder.

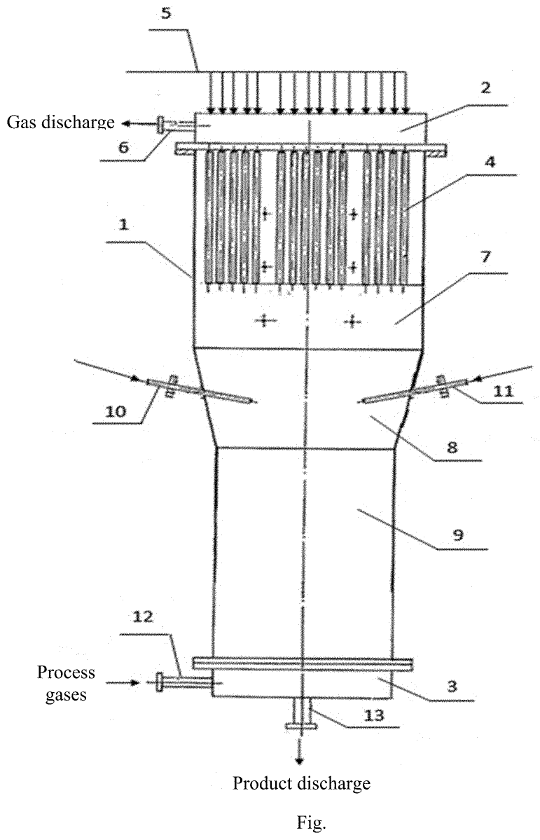

### TECHNICAL FIELD OF THE INVENTION

The invention relates to methods of extraction of metal compounds, specifically—to tools for uranium hexafluoride (UF₆) conversion into uranium dioxide (UO₂) ceramic powder (up to 5% enrichment of U²³⁵) by applying method of reductive pyrohydrolysis.

The process is described by the following chemical reactions:

UF_{6(g)}+2H₂O_{(g)}→UO₂F_{2(g)}+4HF_{(g)} (1);

UO₂F_{2(g)}+H_{2(g)}→UO_{2(g)}+2HF_{(g)} (2).

### PRIOR ART

The facility for extraction of powder of uranium dioxide from uranium hexafluoride, comprising reaction chamber for formation of uranyl fluoride by applying hydrolysis of uranium hexafluoride in presence of water steam and a rotating tube furnace connected to it for subsequent extraction of uranium dioxide by reduction of uranyl fluoride with hydrogen, equipped with heating devices and supply of water steam and hydrogen in counterflow (see Russian patent No. 2162058).

The drawback of the facility is separation of uranium oxide extraction of chemical reaction into several stages, performed in different units, which leads to an increase of dimensions of facility and an increase of operating costs.

The closest in technical essence and achieved result to the applied invention is facility for implementation of the method of extraction of uranium dioxide from uranium hexafluoride by method of pyrohydrolysis, comprising a heated reaction chamber, having a filtration area with a system of filter regeneration, the first reaction zone for conversion of uranium hexafluoride into uranyl fluoride and the second

reaction
zone with a gas-distribution grid for building up a fluidization layer for uranyl fluoride reduction into uranium dioxide, discharge devices of extracted powder of uranium dioxide (see Russian patent No. 2381993)—prototype.

The drawback of the facility is deposits on reaction chamber walls and filtration components, semi-products deposits of conversion reaction of uranium hexafluoride into dioxide, comprising mostly of uranyl fluoride and uranium oxide concentrate: solid deposits are localized in the upper angle of filtration area, opposite to the nozzle of uranium hexafluoride, hydrogen and water steam mixture supply. Localization place is based on interaction of uranium hexafluoride, hydrogen and water steam mixture flow, fed through nozzle into through reaction area and mixture of water steam, hydrogen and nitrogen, supplied into the lower reaction area under the gas-distribution grid.

In the process of such interaction within the reaction chamber nonuniform load can be observed onto fine fraction filtration components of solid products particles (UO₂F₂, U₃O₈ ETC . . . of uranium hexafluoride pyrohydrolysis, thus filter regeneration system applying method of nitrogen backflow not always handles its task to provide complete filter regeneration, especially those, that are located in the upper angle of filtration area in location of solid deposits concentration.

As a result of incomplete regeneration of filters, they are gradually clogged with pyrohydrolysis products of uranium hexafluoride. Consequently there is an increase of hydraulic resistance of the reaction chamber as a whole, which leads to a need for long shutdown of the process for cooldown of the reaction chamber and change of metalceramic filters.

The main reason of formation of uranium hexafluoride pyrohydrolysis reaction semi-products is lack of response time, necessary for particles formation of uranyl fluoride, capable of moving from the first reaction zone into the second reaction zone, where reduction of particles of uranyl fluoride to uranium dioxide in fluidisation layer occurs.

The lack of time factor leads to formation of fine fraction of uranium fluoride and uranium oxide concentrate and their intensive advection into the filtration system, which inevitably leads to clogging of filtration components.

### DISCLOSURE OF THE INVENTION

The technical task of the invention is to extend time between overhaul of the reaction chamber, increase of operating life of the filtration components and increase in performance at the cost of minimization of semi-product formation.

The set task is solved in the reaction chamber for extracting powder of uranium dioxide by means of reductive uranium hexafluoride pyrohydrolysis, comprising a shell, equipped with upper and lower heads and having following areas: upper filtration area, equipped with metalceramic filters, regenerating nitrogen, the first reaction zone for conversion hexafluoride into uranyl fluoride, while in the first reaction zone of the shell there is a nozzle for supply of uranium hexafluoride, hydrogen and water steam, the second reaction zone with a gas-distribution grid for building up a fluidization layer for reduction of uranyl fluoride into uranium dioxide with a nozzle supplying mixture of steam, hydrogen and nitrogen, equipped with a device for discharge of powder, according to the invention, the first reaction zone of the chamber shell is additionally equipped with a second nozzle for supplying uranium hexafluoride, hydrogen and water steam, located on the side wall of the shell symmetrically to the first nozzle. The set task is solved with both nozzles for supplying uranium hexafluoride, hydrogen and water steam are made movable vertically. The task is solved also when one nozzle of the reaction zone is fed with uranium hexafluoride, and the other with hydrogen and water steam in equivalent amount.

Supply of the first reaction zone of the shell of the reaction chamber with an additional nozzle for supplying uranium hexafluoride, hydrogen and water steam and its symmetrical location to the nozzle on the reacting chamber shell allows it to straighten the flow of gases in the upper filtration area across its walls to provide even load

of the
filters through supplying fine particles, generated by uranium hexafluoride pyrohydrolysis, respectively provide even regeneration of all filters when air backflowing, exclude fast depositing of the filters with products of uranium hexafluoride pyrohydrolysis.

Making the nozzles for supply of uranium hexafluoride, hydrogen and water steam movable vertically allows adjusting the angle of inclination of nozzles, which further makes it possible to influence residence time of uranyl fluoride generated particles in the first reaction chamber and shape the size of solid particles of required size. In addition, there are conditions for formation of uranium fluoride and uranium oxide by reaction (3), and hence decreased loads on the filtration components in general:

3UO₂F_{2(g)}+3H₂O_{(g)}→U₃O_{8(g)}+1,5O_{2(g)}+6HF_{(g)} (3).

Supply of hydrogen into the first reaction chamber through an additional nozzle allows increasing concentration of hydrogen and increasing the speed of reaction flow of postreduction of uranyl fluoride and uranium fluoride and uranium oxide fine particles by reactions (2) and (4):

U₃O_{8(g)}+2H_{2(g)}→3UO_{2(g)}+2H₂O_{(g)} (4)

without influence on the hydrodynamic conditions of reduction process of uranyl fluoride with hydrogen in the “boiling” layer of the second reaction zone.

Separation of uranium hexafluoride supply into one nozzle and hydrogen with water steam into another allows to more precisely adjust supply into the reaction chamber of each component of the mixture, thus influence the qualitative and quantitative indicators in general.

### BRIEF DESCRIPTION OF DRAWINGS

The essence of the invention is explained by the drawing.

FIG. shows reaction chamber for extraction of uranium dioxide powder by using method of uranium hexafluoride reductive pyrohydrolysis.

The reaction chamber comprises shell 1, upper head 2 and lower head 3 with a gas-distribution grid (not shown), sealed between each other with flange connections. On the upper head 2 there are tightly connected replaceable metalceramic filters 4. Each metalceramic filter 4 is equipped with an inlet system 5, installed on the upper head 2, for intermittent nitrogen supply for filter regeneration. In the side wall of compensating volume of the upper head 2 there is a nozzle 6 provided for outflow of discharge gases.

The shell 1 of the reaction chamber comprises of the upper filtration area 7, where metalceramic filters 4 are installed, located in the upper area of the shell 1, the first reaction zone 8 for converting hexafluoride into uranyl fluoride and the second reaction zone 9 for building up fluidization layer for reduction of uranyl fluoride into uranium dioxide.

The first reaction zone 8 of the shell of the reaction chamber connects the upper filtration area 7 with the second filtration area 9 of the fluidization layer. In the first reaction zone 8 there are two nozzles 10 and 11 located symmetrically for supply of uranium hexafluoride, hydrogen and water steam. The lower head 3 is equipped with nozzle 12 for supply of steam, hydrogen and nitrogen mixture into it and nozzle 13 of device for powder discharge, tightly connected with gas-distribution grid.

### BEST EMBODIMENT OF THE INVENTION

The reaction chamber works the following way.

The reaction chamber is preliminarily heated up to temperature of 450°-500° C. in the upper filtration area 7 and in the first reaction zone 8 and to 580°−635° C. in the second reaction zone 9. Into the first reaction zone 8 through nozzles 8 and 11 symmetrically located on the opposite walls of the shell 1 of the first reaction zone 8, uranium hexafluoride, hydrogen and water steam is supplied. Inserted reagent enter into a reaction with each other, while uranyl fluoride powder is formed, large fraction of which goes down to the second reaction zone 9 of fluidization layer and is slowed down by gas-distribution grid of the lower head 3, and fine fraction particles go up, slowed down by metalceramic filters 4 and occasionally regenerated by nitrogen air backflow. Nitrogen-blown particles of uranyl fluoride get into fluidization layer of the second reaction zone 9.

Through nozzle 12 of the lower head 3 under gas-distribution grid a mixture of water steam, hydrogen and nitrogen is supplied, creating fluidization layer above gas-distribution grid, in which there is reduction of uranyl fluoride to uranium dioxide is performed. As it accumulates, uranium dioxide powder is removed from the reaction chamber through nozzle 13 of device for discharge of powder from the reaction chamber.

Symmetrical location of nozzles 10 and 11 with equal flows provides flow flattening in the upper filtration area 7 in parallel to its walls and provides equal load on filters 4. As a result increases time between overhaul of the reaction chamber. Exclusion of accumulation of semi-products leads to an increase of th reaction chamber performance.

### INDUSTRIAL APPLICABILITY

Thus, supplying of the reaction chamber structure for extraction of uranium dioxide powder by method of reductive pyrohydrolysis of uranium hexafluoride with additional nozzle allows to solve the set task of increasing time between overhaul of the chamber, increase operating life of filtration components and achieve increase in performance of the chamber at the cost of minimizing semi-product formation.

What is claimed is:

1. A reaction chamber for extraction of uranium dioxide powder by method of reductive pyrohydrolysis of uranium hexafluoride, which is a shell with upper and lower heads, comprising upper filtration area, equipped with metalceramic filters, regenerating nitrogen, the first reaction zone for conversion of uranium hexafluoride into uranyl fluoride, the second reaction zone with gas-distribution grid for building up fluidization layer for reduction of uranyl fluoride into uranium dioxide with a nozzle of steam, hydrogen and nitrogen supply and equipped with a nozzle for uranium hexafluoride, hydrogen and water steam supply, located on the back wall of the first reaction chamber, characterized in that the shell of the reaction chamber is additionally equipped with second nozzle for uranium hexafluoride, hydrogen and water steam supply located on the wall of the first reaction zone shell symmetrically to the first one.

2. The reaction chamber according to claim 1, characterized by nozzles for uranium hexafluoride, hydrogen and water steam supply that are movable vertically.

3. The reaction chamber according to clause 1, characterized by one nozzle being an inlet for uranium hexafluoride, and the second nozzle being an inlet for hydrogen and water steam supply.
